(19) United States
(12) Patent Application Publication
(10) Pub. No.: US 2025/0320670 A1
(43) Pub. Date: Oct. 16, 2025

(54) METHOD FOR CONTROLLING THE OPERATION OF A FLUID DISPENSING DEVICE OF A GROUND MILLING MACHINE, AND GROUND MILLING MACHINE

(71) Applicant: BOMAG GMBH, Boppard (DE)

(72) Inventors: Andreas ESCH, Boppard (DE); Alexander HUHN, Boppard (DE)

(21) Appl. No.: 19/170,506

(22) Filed: Apr. 4, 2025

(30) Foreign Application Priority Data
Apr. 15, 2024 (DE) 10 2024 110 520.8
Apr. 3, 2025 (EP) 25168238

(51) Int. Cl. E01C 23/06; E01C 21/00; G05D 7/06

(52) U.S. Cl. CPC E01C 23/065; E01C 21/00; G05D 7/0688

(57) ABSTRACT

A method for controlling the operation of a fluid dispensing device of a ground milling machine and a ground milling machine.

### FIELD

The invention relates to a method for controlling the operation of a fluid dispensing device of a ground milling machine and to a ground milling machine.

### BACKGROUND

Ground milling machines, in particular stabilizers for stabilizing particularly non-load-bearing soils and recyclers for restoring road pavements in need of repair, are often used to mill the underlying ground to a milling depth and mix it with water or additional binders such as lime, cement, bitumen emulsion, foamed bitumen or cement suspension. For this purpose, one or more aggregates, in particular in powder form, may be spread on the ground surface, usually in metered quantities, by a preceding auxiliary vehicle, for example a binding agent spreader. This ground surface is then traversed by the ground milling machine, which mixes the aggregate(s) with the ground material, often with the simultaneous addition of a fluid, in particular water. Ground milling machines are also known that directly apply the aggregate(s) to the ground surface and/or dose them directly into a mixing area during the ongoing work process of the ground milling machine. It is also known, especially for recycling applications, to equip the ground milling machine with a foamed bitumen system. This system is configured such that it produces and applies foamed bitumen during the ongoing work process of the ground milling machine.

In order to be able to mix the ground material with the aggregate(s), these ground milling machines have a ground milling device with a milling drum box that encloses a milling drum box interior which is open in vertical downward direction, i.e., towards the underlying ground. A milling drum is arranged in the milling drum box interior. The milling drum may be an essentially hollow cylindrical support tube with a plurality of milling tools arranged on its outer surface. The milling drum can be rotated about a rotation axis, typically horizontal and transverse to a working or forward direction of the ground milling machine, and rotates about said rotation axis during milling operation. In order to be able to mill, crush and/or mix the underlying ground, the milling drum is height-adjustable relative to the underlying ground and can thus engage the underlying ground at different milling depths. Typical dimensions of ground engagement of the milling drum and thus the milling depth are, for example, 30 cm and more. For this purpose, the ground milling machine comprises one or more height adjustment devices, for example in the form of lifting devices, in particular lifting columns, connecting the travel units to a machine frame supporting the milling drum, or additionally or alternatively in the form of a mounting device that is height-adjustable relative to a machine frame of the ground milling machine, for example by means of rotor swivel arms arranged at end faces of the milling drum. The milling drum box may therefore be fixedly connected to the machine frame of the ground milling machine or may also be height-adjustable and/or swivel relative to the machine frame. The milling drum box can provide a controlled mixing chamber in which the milled ground material is mixed with one or more aggregates and/or a fluid, in particular water and/or foamed bitumen. After exiting the milling drum box to the rear in a working direction of the ground milling machine, the mixed ground material usually remains on the ground and is available for subsequent processing steps, for example compaction processes.

A ground milling machine of the type relevant here further comprises a fluid dispensing device. This is a device with which a fluid, usually water and/or foamed bitumen, can be fed from the ground milling machine to the ground material during the ongoing milling operation of the ground milling machine. The fluid is therefore in particular a liquid and/or emulsion and/or a foam. It is known that the fluid dispensing device can have one or more fluid outlets, usually in the form of fluid nozzles. These may be positioned such that the fluid emerging from them flows directly into the milling drum box interior and is thus fed directly into the mixing process that takes place there. The metered supply of one or more fluids in the ongoing work process of the ground milling machine is particularly important if the ground material is to have a certain moisture content over the entire working area, for example in order to be able to react effectively with the mixed-in aggregates, and/or if foamed bitumen is to be produced from heated bitumen and water supplied to it.

It is also already known to control the operation of the fluid dispensing device with the aid of a control device. Control operations may include, for example, activating and deactivating the fluid dispensing device and/or changing the dispensed quantity of fluid per time unit and/or distance unit.

The required fluid quantities may vary depending on the operating conditions. Recycling applications, for example, often require comparatively little water (e.g. approx. 100-300 l/min), whereas stabilization applications, for example, often require 400-600 l/min, sometimes even up to 1600 l/min, to be conveyed into the working chamber by the fluid dispensing device.

Milling machines are often used at intervals over comparatively short sections of the entire route to be worked, for example when they are to mix an aggregate previously deposited on the ground surface into the ground material, as the loading capacities of the binding agent spreading vehicles are limited and/or a loss of material due to drifting is to be kept to a minimum. The ground milling machines then often process these comparatively short sections such that they traverse the entire surface in several processing strips running parallel to each other and/or adjoining each other at front sides when viewed in a processing direction. Due to the design of the milling drum, processing is usually always carried out in the forward direction of the ground milling machine, so that the ground milling machine must either turn or reverse at the end of a processing strip. This means that the milling drum has to be adjusted comparatively frequently from the milling position, which engages in the underlying ground, to a transport position that is raised relative to the underlying ground and vice versa. Additionally or alternatively, it may be necessary to refill operating materials carried by the ground milling machine, such as fluids, in particular water and/or bitumen, but also fuel, which also interrupts the work process and also requires the milling drum to be moved from the milling position engaging in the underlying ground to the transport position raised relative to the underlying ground and then to be lowered back into the milling position to continue the work process.

The area where the milling drum is lowered from the transport position into the milling position to a milling depth is also referred to below as the initial contact point. In particular this ground area and, in practice, the first few meters (in particular 1 m to 3 m) of the processing section adjoining this ground area (i.e., the area of the initial contact point and the first few meters adjoining this ground area, in particular for example three meters), which are also referred to as the initial contact area, are challenging with regard to the uniform metering of the fluid compared to the normal milling area adjoining the initial contact area, in which the ground milling machine usually moves with comparatively constant operating parameters, in particular with regard to milling depth, travel speed and/or fluid metering per unit of time and/or unit of distance. Unlike in the normal milling area, the operating parameters are not constant here, as the specified or defined milling depth must first be reached by height adjustment of the milling drum relative to the underlying ground from the transport position to the milling position and the fluid dispense and travel of the ground milling machine must first be started.

### SUMMARY

Against this background, the object of the invention is therefore to provide a way of improving the operation of the ground milling machine at the start of a milling operation.

The object is achieved with a method for controlling the operation of a fluid dispensing device of a ground milling machine and a ground milling machine according to the independent claims. Preferred embodiments are cited in the dependent claims.

A first aspect of the invention relates to a method for controlling the operation of a fluid dispensing device of a ground milling machine at the start of a milling operation. Milling operation refers in particular to the operating phase in which a milling drum of the ground milling machine is in contact with the underlying ground and mills, crushes and mixes ground material. The start of the milling operation refers in particular to the operating phase in which the milling drum is lowered from a transport position raised relative to the underlying ground during an adjustment into a milling position in engagement with the underlying ground and the ground milling machine starts its travel operation in a forward or working direction until, for example, an essentially constant travel speed is reached. When the ground milling machine is in milling operation and is moving in a working or forward direction relative to the underlying ground, i.e., is moving along a milling track, the ground milling machine is in working operation. The operating phase of the milling operation, in which the ground milling machine does not move relative to the underlying ground and the milling drum rotates about its rotation axis, is referred to as standstill operation.

The ground milling machine may have a machine frame supported by travel units, in particular wheels and/or crawler tracks. The machine frame refers in particular to a frame-like supporting structure of the ground milling machine. Some or all of the travel units may be connected to the machine frame via lifting devices, in particular lifting columns, so that the machine frame and the elements of the ground milling machine fixedly connected to it are height-adjustable relative to the ground. An operator platform may be mounted on the machine frame, from which the ground milling machine can be operated by an operator located on the operator platform. The operator platform may be separately height-adjustable relative to the machine frame. The machine frame may also be an articulated machine frame with a front frame and a rear frame, which are connected to each other via an articulated joint device. The ground milling machine may have a travel drive device that at least partially drives the travel units. All of the travel units may be directly or indirectly driven. In particular, individual or all travel units may each have a hydraulic or electric travel drive motor.

The ground milling machine comprises a ground milling device with a milling drum arranged inside a milling drum box interior and rotatable about a rotation axis during a milling operation for milling and/or mixing the ground substrate. The milling drum may be an essentially hollow cylindrical support tube with a plurality of milling tools arranged on its outer surface. The milling drum can be rotated about a rotation axis, typically horizontal and transverse to a working or forward direction of the ground milling machine, and rotates about said rotation axis during milling operation. The milling drum is arranged on the ground milling machine such that it can be adjusted between a transport position in which it is lifted out of the underlying ground and a milling position in which it is immersed in the underlying ground. In the transport position, the milling drum is therefore not in contact with the ground. The milling drum box surrounds the milling drum to the sides and upwards and forms a mixing chamber in the interior of which the milling drum can crush ground material and/or mix it with one or more fluids and/or powdered aggregates during milling operation. The milling drum box may be at least partially fixed to the machine frame or alternatively be height-adjustable relative to the machine frame. The height adjustment of the milling drum box may be carried out independently of the height adjustment of the milling drum at least within a defined range. In addition, the milling drum box may comprise adjustable wall elements, such as a front flap, side shields and/or a scraper flap.

The ground milling machine further comprises the fluid dispensing device. The fluid dispensing device is a device that enables fluid to be dispensed by the ground milling machine. In particular, the fluid may be water and/or foamed bitumen. It is particularly preferred if the fluid dispensing device dispenses the fluid into the interior of the milling drum box of the ground milling device. The fluid dispensing device comprises a fluid source. The fluid source refers in particular to a point or an area of the ground milling machine via which the fluid is supplied during milling operation. The fluid source may, for example, be a fluid tank, in particular a water tank, carried by the ground milling machine. This tank may typically have a capacity of more than 500 l, in particular more than 800 l. Additionally or alternatively, the fluid source may also be a fluid supply connection via which the fluid dispensing device may be connected, or is connected during ongoing working operation, to an external supply vehicle, for example a water truck, a bitumen truck, etc., to supply fluid. This vehicle may be connected to the ground milling machine via a push or pull rod and pulled/pushed by it during operation.

The fluid dispensing device further comprises a fluid outlet device. The fluid outlet device refers in particular to the point or points at which the fluid emerges from the fluid dispensing device, in particular into the milling drum box interior and/or the external environment. For this purpose, the fluid outlet device may have one or more exit points, for example outlet openings from a fluid delivery line and/or one or more fluid nozzles. Fluid nozzles are advantageous in that the nozzles themselves can be used to create a fanned-out fluid exit jet, for example, which allows the fluid to be distributed more evenly as it exits the outlet opening. The fluid dispensing device may, for example, comprise multiple spray nozzles. These nozzles may, for example, be arranged along one or more spray bars, in particular arranged in the milling drum box interior or at least directed into the milling drum box interior.

Part of the fluid dispensing device is also a fluid feed pump, which delivers fluid from the fluid source in the direction of the fluid outlet device via a fluid delivery line. The fluid feed pump may be a dynamic pump or a positive displacement pump, for example. The fluid feed pump may thus be a rotary pump (for example a gear pump or rotary piston pump), a diaphragm pump, an eccentric worm shaft pump, a centrifugal pump or the like. The fluid feed pump is adjustable between delivery operation, in which it delivers fluid from the fluid source towards the fluid outlet, and an inactive state, in which it stands idle and/or at least does not deliver any fluid. The fluid feed pump may further be configured such that one or more of its operating parameters, such as its delivery rate, in particular its speed and/or its displacement volume, can be varied gradually or continuously within defined ranges during delivery operation. The fluid delivery line establishes a fluid-conducting connection between the fluid source and the fluid outlet device. This connection may be a pipe and/or hose line. Branches and/or junctions may be included. In particular, it is also possible for the fluid delivery line to have one or more branches downstream of the fluid delivery pump, for example in order to distribute fluid delivered by the fluid delivery pump to separate line sections and thus feed it to different exit points of the fluid outlet device. The fluid delivery line thus refers to the fluid line system as a whole, in particular downstream or in the delivery direction of the fluid delivery pump to the fluid outlet device.

Finally, the fluid dispensing device comprises a valve device in a delivery area of the fluid delivery line between the fluid delivery pump and the fluid outlet device. The valve device may comprise one or more individual valves, which are configured in particular such that they interrupt or block or release the fluid flow from the fluid delivery pump to the fluid outlet device. The valve device is thus adjustable between a blocking position, in which a fluid connection from the fluid delivery pump to the fluid outlet device is blocked, and an outlet position, in which a fluid connection from the fluid delivery pump to the fluid outlet device is released and, accordingly, fluid can be delivered from the fluid delivery pump to the fluid outlet device and exits there from the fluid outlet device.

The drive energy required for operating the ground milling machine, in particular also for driving the travel drive device, the ground milling device and/or the fluid dispensing device, may be provided by one or more motors, in particular, for example, an internal combustion engine as the primary drive unit and/or by one or more electric motors.

The ground milling machine may comprise a control device configured to control one or more of the elements of the fluid dispensing device described above, in particular the fluid delivery pump and the valve device. For this purpose, the control device may be connected to these elements of the fluid dispensing device via suitable signal transmission lines. The control device may be a computer device in particular.

Based in particular on a ground milling machine described above, the method according to the invention may now comprise a step I.) of positioning the milling drum arranged in the transport position at an initial contact point. This means that the milling drum or the ground milling machine with the milling drum is positioned on or above the ground surface such that it can be adjusted, usually lowered, from the transport position to the milling position in a predetermined area of the ground to be worked, thereby engaging the ground. If, for example, a ground surface to be worked is to be processed in several processing strips each extending over a length of the ground surface, an operator of the ground milling machine typically selects an end-side edge area of the ground surface to be worked as the initial contact point. If the working area consists of several ground surface segments successively adjoining one another in a longitudinal direction, the initial contact point is thus usually selected in the area that adjoins the end edge of a ground surface segment that has already been processed. Irrespective of this, the initial contact point thus refers to the point or area of the ground to be worked on at which the milling drum will engage the ground when moving from the transport position into the milling position.

During step I.) or afterwards, a step II.) of activating the milling operation of the milling drum situated in the transport position is performed, i.e., the milling drum is set in rotation about its rotation axis. This can be done by activating a milling drum drive motor, for example a hydraulic or electric motor, and/or by engaging a drive train connected to a primary drive unit, for example an internal combustion engine.

The method now comprises a step III.) of lowering the milling drum from the transport position into the milling position at a defined milling depth. The rotating milling drum thus comes into contact with the ground and mills ground material. The defined milling depth refers to a milling depth specified, for example, by an operator and/or an automatic milling depth control system. This does not mean that the milling drum can only be lowered to a certain milling depth. Usually, the milling depth can be freely selected and adjusted in a range from >0 cm to a maximum milling depth, for example a maximum of 65 cm, depending on the tooling of the milling drum. The defined milling depth therefore indicates a current target milling depth. In particular, the ground milling machine is in standstill mode, i.e., the milling drum rotates about its rotation axis, mills ground material and/or moves it, but the ground milling machine itself does not yet move in the working or forward direction.

In the course of steps I.) to III.), particularly during step III.), and/or upon reaching the defined and/or predetermined milling depth, a step IV.) of activating the delivery operation of the fluid delivery pump is performed with the valve device being in the blocking position. The fluid feed pump thus delivers or pushes fluid into the fluid feed line without simultaneously discharging fluid from the fluid delivery line via the fluid outlet device. This therefore occurs in particular while the milling drum is immersed in the ground at the milling depth during milling operation when the machine is stationary. In this way, fluid pressure is built up within the fluid delivery line while the milling drum is rotating and in contact with the ground, without any fluid exiting the fluid outlet device. In other words, the fluid dispensing device is preloaded, in particular hydraulically, in the area downstream of the fluid delivery pump towards the fluid outlet device, specifically up to the valve device in the blocking position.

During steps I.) to IV.), the ground milling machine is ideally at a standstill or on the spot and therefore does not move in the working or forward direction. In other words, it has not yet started traveling operation. A step V.), specifically after steps I.) to IV.), of switching the valve device from the blocking position to the release position depending on a start of traveling operation of the ground milling machine is then performed. The switching thus especially occurs while the milling drum is already in milling operation, rotating and in contact with the ground. In other words, the valve device is released during milling operation depending on a change of the ground milling machine from standstill operation to working operation. This means that the valve device is switched to the release position and fluid is dispensed via the fluid outlet device when the ground milling machine starts to move in the working or forward direction during milling operation, i.e., starts traveling operation. Due to the fact that the fluid dispensing device is preloaded as described above, fluid is suddenly dispensed from the fluid outlet device in this phase, i.e., the delivery rate per unit of time desired for normal operation is provided almost immediately. It is also possible for a comparatively large dispensing surge to occur initially in terms of the dispensed volume of the fluid, for example due to elasticities or the like provided in the fluid delivery line and/or the fluid delivery pump. In this way, a fluid surge is generated so that a certain volume of fluid emerges almost abruptly from the fluid dispensing device, in particular into the interior of the milling drum box. The fluid volume of this fluid surge is immediately worked into the underlying ground by the milling drum, which is already in milling operation at the defined milling depth. In the case of continued ground working, this fluid surge is followed by constant delivery operation provided by the fluid delivery pump.

All in all, in the area of the initial contact point, this prevents an introduction of an insufficient amount of fluid for the initial area of the milling route, as the desired fluid delivery volume is fully available practically as soon as traveling operation starts due to the aforementioned preloading of the fluid dispensing device.

It is particularly preferred if the fluid outlet device dispenses the fluid directly into the milling drum box interior. In this way, the fluid can be added directly to the mixing process taking place inside the milling drum box. Furthermore, the at least almost complete introduction of fluid takes place especially initially at the beginning of a milling track when starting working operation.

It is possible if, in particular before or during one or more of steps I. to III, a manual specification or determination of a normal dosage specification takes place, in particular a normal fluid flow or a specification in “fluid volume per meter of underlying ground”, i.e., in particular a time-and/or distance-dependent normal dosage specification. This can be a percentage specification, for example, specifying the percentage of fluid to be added to the ground. Furthermore, there is often a construction management specification in mass per square meter of aggregate and mass percent of added fluid. A density may also be set. Taking into account the milling width, the milling depth and the (planned) travel speed, a fluid mass flow per time unit can then be determined. The latter may also be the control variable of a control system. The normal dosage specification therefore refers to a control specification as to how much fluid should be dispensed by the fluid dispensing device into the underlying ground per time unit and/or per distance unit during working operation of the ground milling machine. Based on this, the method may now comprise determining, for example by a control device, a starting dosage specification or an initial saturation dosage, in particular a starting fluid flow, and/or a preload pressure as a function of the defined and/or specified milling depth and/or the normal dosage specification. The starting dosage specification may deviate from the normal dosage specification and, in particular, may be larger than the normal dosage specification. A step VI.) comprises switching from an operation of the fluid dispensing device with a fluid output according to the starting dosage specification to an operation of the fluid dispensing device with a fluid output according to the normal dosage specification. The change may be abrupt, but may also be gradual.

As a result of the aforementioned preloading of at least one area of the fluid delivery line between the fluid delivery pump and the fluid dispensing device, in particular one or more fluid valves of the valve device, the internal pressure within the fluid delivery line increases. A pressure limiting device may be provided in the delivery area of the fluid delivery line between the fluid delivery pump and the fluid outlet device. A pressure limiting device may be, for example, a pressure limiting valve or the like. The pressure limiting device can be used to ensure that the internal pressure within the fluid delivery line between the fluid delivery pump and the fluid dispensing device only rises up to a defined and predetermined maximum pressure value. In particular, if a pressure threshold value specified by the pressure limiting device is exceeded, one or more measures may be taken to counteract a further increase in internal pressure. If a pressure threshold value specified by the pressure limiting device is exceeded, the delivery operation of the fluid delivery pump may be reduced or stopped, for example. Additionally or alternatively, it is possible for fluid delivered by the fluid delivery pump to be drained or discharged from the fluid delivery line via a bypass line. In this case, the fluid delivery pump may therefore continue to deliver fluid without the internal pressure inside the fluid delivery line increasing any further. It is possible that fluid discharged from the fluid delivery line in the area between the fluid delivery pump and the fluid delivery device via the pressure limiting device is fed back via a return line into a fluid source configured as a fluid tank, in particular as a fluid tank of the ground milling machine.

The pressure limiting device may be configured such that it is triggered, for example in the manner described above, when a defined pressure threshold value is exceeded. However, it is also possible for the pressure limiting device to be configured such that its pressure threshold value can be changed. For this purpose, the pressure limiting device may, for example, be controlled manually or by a control device with regard to a current pressure threshold value, for example depending on an operating parameter of the ground milling machine, in particular depending on a specified milling depth. It is therefore possible to change the pressure threshold value as a function of a defined and/or specified milling depth. In particular, this is done such that the specified pressure threshold value increases as the milling depth increases.

The method according to the invention may comprise measuring the internal pressure of the fluid delivery line in the area between the fluid delivery pump and the fluid delivery device. For this purpose, one or more fluid pressure sensors may be provided, which are connected to the control device for signal transmission.

There are various ways to determine the switching of the ground milling machine during milling operation from standstill operation to working operation. This can be done, for example, with the aid of an intrinsic indicator that occurs during operation of the ground milling machine, for example depending on a travel control command, in particular a travel lever deflection, and/or a travel unit movement. It is understood that one or more suitable sensors may be provided for this purpose, for example to directly or indirectly determine a travel lever deflection and/or a movement of one or more of the travel units. Additionally or alternatively, it is also possible to determine the switching of the ground milling machine during milling operation from standstill operation to working operation using an extrinsic indicator that occurs during operation of the ground milling machine, for example using a device that detects an actual movement of the ground milling machine relative to the underlying ground, for example using a camera and/or a ground sensor.

The extent to which the area of the fluid delivery line between the fluid delivery pump and the fluid dispensing device is preloaded may also vary. It can essentially be limited to a pure pressure increase, especially if the fluid line system essentially comprises rigid pipelines. The fluid volume held by the fluid delivery line in the area between the fluid delivery pump and the fluid dispensing device in the preloaded state then essentially corresponds to the fluid volume held in this area of the fluid delivery line in normal operation. However, it is also possible that a significant additional volume of fluid is held in this area when the pressure within the fluid delivery line is increased. This can be done, for example, with the help of at least partially existing elastic line sections and/or special storage units provided for this purpose. Overall, step IV.) may therefore comprise filling a fluid pressure accumulator in the delivery area of the fluid delivery line between the fluid delivery pump and the fluid outlet device, and that step V.) comprises emptying the fluid pressure accumulator in addition to delivering fluid through the fluid delivery pump towards the fluid dispensing device. In this way, for example, with constant delivery operation of the fluid delivery pump, immediately after switching the milling operation from standstill operation to working operation, a comparatively larger volume flow initially emerges from the fluid dispensing device, which then drops to the fluid flow delivered by the fluid delivery pump alone. In this way, an initial surge emerging from the fluid dispensing device can be generated when switching from standstill operation to working operation in order to immediately ensure a sufficiently high fluid concentration in the milled material at the start of a milling track.

The fluid dispensed into the milled material via the fluid dispensing device is often water. This can be used in particular to react with powdered aggregates, such as lime or cement, mixed into the milled material. However, there are also known applications, particularly in the recycling sector, in which foamed bitumen is produced by the ground milling machine and mixed into the milled material. Accordingly, the ground milling machine may be configured to produce foamed bitumen and may comprise two fluid dispensing devices, specifically a fluid dispensing device for water and a fluid dispensing device for bitumen. The two fluid dispensing devices open with their fluid outlet devices into one or more mixing chambers, in which the foamed bitumen is then produced by reacting these two fluids with each other. The one or more mixing chambers have a foamed bitumen outlet, in particular into the milling drum box interior. For the method according to the invention, it may now be envisaged in particular that the two fluid dispensing devices are both controlled according to one of the methods according to the invention described above.

A further aspect of the invention relates to a ground milling machine, in particular a ground milling machine configured to carry out a method according to the invention as described above.

The ground milling machine according to the invention comprises a machine frame supported by travel units, a travel drive device at least partially driving the travel units, a ground milling device with a milling drum arranged within a milling drum box interior and rotatable about a rotation axis in a milling operation for milling and mixing the underlying ground, wherein the milling drum is adjustable between a transport position lifted out of the underlying ground and a milling position engaging the underlying ground.

Part of the ground milling machine according to the invention is also a fluid dispensing device comprising a fluid source, a fluid outlet device, a fluid delivery pump which, when in delivery operation, delivers fluid from the fluid source towards the fluid outlet device via a fluid delivery line, and a valve device in a delivery area of the fluid delivery line between the fluid delivery pump and the fluid outlet device, the valve device being adjustable between a blocking position and an outlet position.

With regard to further details and features of the possible configuration of the ground milling machine, reference is also made in particular to the information relating to the ground milling machine and its possible configuration in connection with the description of the method according to the invention. These are hereby also referred to with respect to the ground milling machine according to the invention.

The ground milling machine according to the invention may comprise a control device configured to control the operation of the fluid dispensing device according to the method of the invention as described above.

The ground milling machine may have a traveling operation sensor, in particular a travel lever position sensor and/or a travel unit movement sensor, which is configured to determine the initiation and/or occurrence of a traveling operation. The travel lever position sensor directly or indirectly determines the current position of a travel lever of the ground milling machine, which an operator of the ground milling machine can use to control the traveling operation of the ground milling machine. Said lever may be a joystick, for example. The traveling operation sensor may also be a travel unit movement sensor configured to directly or indirectly determine a traveling movement of one or more of the travel units, for example a speed and/or rotational direction sensor. Additionally or alternatively, the traveling operation sensor may also be configured such that it detects an actual travel movement of the ground milling machine, in particular in a working or forward direction, relative to the outside environment, in particular the ground surface. It may, for example, be a camera configured to detect and monitor a relative movement of the ground milling machine relative to the outside environment using a suitable image evaluation computer program, for example by comparing two images taken in succession. Preferably, a signal transmission connection is provided via which the one or more traveling operation sensors transmit the milling depth data recorded and/or monitored by them to the control device.

The ground milling machine may additionally or alternatively have one or more milling depth sensors configured to determine a defined and/or present milling depth. The at least one milling depth sensor may thus be configured to detect a specified milling depth and/or to detect an actual milling depth. The milling depth sensor may, for example, be a distance sensor that determines and/or monitors the distance between a reference point fixed relative to the rotation axis of the milling drum and the underlying ground. Additionally or alternatively, the milling depth sensor may also be a displacement sensor of a lifting device of the milling unit, the lifting adjustment of which directly or indirectly causes a change in the current milling depth or correlates with it. It is also possible, additionally or alternatively, for the milling depth sensor to have one or more sensing devices whose sensing position and/or differential sensing position can be used as a measure of a current milling depth. Preferably, a signal transmission connection is provided via which the one or more milling depth sensors transmit the milling depth data recorded and/or monitored by them to the control device.

The ground milling machine may comprise one or more fluid pressure sensors configured such that they can be used to detect a fluid pressure existing in one or more areas of the fluid delivery line between the fluid delivery pump and the fluid outlet device. Preferably, a signal transmission connection is provided via which the one or more fluid pressure sensors transmit the milling depth data and/or milling pressure data recorded and/or monitored by them to the control device.

The ground milling machine may be configured such that a pressure limiting device, in particular one controlled by the control device, is present in an area of the fluid delivery line between the fluid delivery pump and the fluid outlet device, in particular the valve device. Reference is further additionally made to the features for the possible configuration and control of the pressure limiting device according to the preceding discussion of the method according to the invention.

A bypass line may be provided, via which fluid can be discharged from an area of the fluid delivery line between the fluid delivery pump and the fluid outlet, in particular with recirculation to the fluid source. In particular, the bypass line may be configured such that it branches off from a pressure limiting device and in this way enables a fluid flow within the fluid delivery line without fluid being discharged from the fluid outlet device to the outside environment.

The ground milling machine may comprise a control device, in particular for controlling the fluid dispensing device, especially for controlling the fluid delivery pump and the fluid outlet device, in particular the valve device, and, if present, the pressure limiting device. The control device may have a computing unit configured to calculate a normal dosage specification and/or a starting dosage specification and/or a pressure threshold value as a function of a defined and/or specified milling depth. In particular, a dosage specification may be a pressure value within the fluid delivery line, especially in the area between the fluid delivery pump and the fluid outlet device, a delivery volume or displacement volume of the fluid delivery pump, a speed of the fluid delivery pump, etc. In particular, the starting dosage specification refers to a dosage specification that should be available at the latest at the time of switching from standstill operation to working operation of the ground milling machine. The normal dosage specification refers to a dosage specification that should be achieved during ongoing working operation of the ground milling machine and then maintained during working operation.

### BRIEF DESCRIPTION OF THE DRAWINGS

The invention will be explained in more detail below by reference to the embodiment examples shown in the figures. In the schematic figures:

FIG. 1 shows a side view of a ground milling machine;

FIG. 2 is a schematic diagram of a ground milling device;

FIG. 3 shows a first embodiment of a fluid dispensing device;

FIG. 4 shows a second embodiment of a fluid dispensing device;

FIG. 5 shows a third embodiment of a fluid dispensing device;

FIG. 6 shows a top view of a working area of the ground milling machine;

FIG. 7 is a flow chart of a method for controlling the operation of a fluid dispensing device of a ground milling machine; and

FIGS. 8A to 8E show curves of several operating parameters of a ground milling machine.

### DETAILED DESCRIPTION

Like parts or functionally like parts are designated by like reference numerals in the figures. Recurring parts are not necessarily designated separately in each figure.

FIG. 1 shows a side view of a ground milling machine 1. The ground milling machine may be a stabilizer or recycler. The ground milling machine 1 may comprise travel units 2, in particular wheels and/or crawler tracks, a machine frame 3, travel drive devices 4, for example in the form of hydraulic motors, a ground milling device 5, a fluid dispensing device 6, a primary drive unit 7 and a control device 8. The ground milling machine can be operated from an operator platform 9. The operator platform be height-adjustable (the lowered driver's cab is indicated by a dashed line in FIG. 1). The machine frame 3 may comprise a front carriage and a rear carriage, which are connected to each other via an articulated joint.

The structure and mode of operation of the fluid dispensing device 6 is explained in more detail below, in particular with reference to the exemplary embodiments described in more detail below. Part of the fluid dispensing device 6 are a fluid source 10 and a fluid outlet device 11. These may be connected to each other via a fluid delivery line 13. The fluid can be delivered from the fluid source 10 to the fluid outlet device 11 within the fluid line 13 using a fluid delivery pump 14. At the fluid outlet device 11, for example, the fluid may exit the fluid dispensing device 6 into a milling drum box interior 15 (fluid outlet direction B in FIG. 1). For this purpose, the fluid outlet device 11 may be configured as one or more fluid nozzles, for example.

The milling drum box interior 15 may be open in vertical downward direction towards the ground surface 18 and may be bounded to the sides and upwards by a milling drum box 16. The milling drum box 16 may be in the shape of a box and/or hood and, in addition to wall elements that are essentially stationary relative to one another, can also have wall elements that are height-adjustable relative to the stationary wall elements, for example so-called side shields and, in particular, one or more front and/or rear scraper shields. A milling drum 17 is arranged in the milling drum box interior 15. The milling drum can be rotated about a rotation axis R. A milling drum drive or milling drum drive train, not shown in detail in the figures, is provided for this purpose. The milling drum may be an essentially hollow cylindrical support tube with a plurality of milling tools arranged on its outer surface. In milling operation, the milling drum 17 engages the underlying ground 19 at a milling depth FT and mills and/or mixes the ground material.

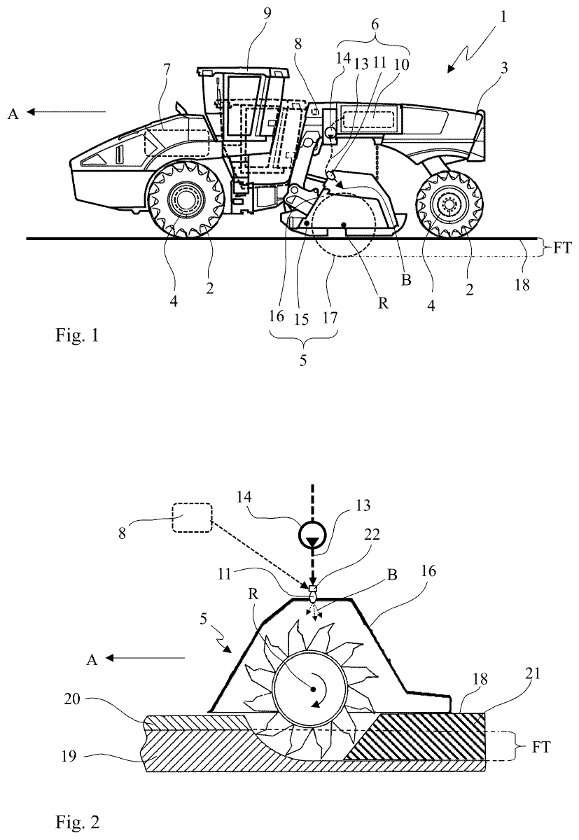

FIG. 2 illustrates further details of the ground milling machine 1, in particular the ground milling device 5 and the fluid dispensing device 6, as well as a possible application scenario, in a schematic diagram.

On the left in FIG. 2 is ground still to be worked. In addition to the ground material 19, it comprises an aggregate 20, for example in powder form, such as lime and/or cement, applied to the surface of the ground material. If this area is traversed by the ground milling device 5 in a working or forward direction of the ground milling machine 1, the ground material 19 is milled to the milling depth FT together with the layer of aggregate 20. In the present embodiment example, the fluid outlet device 11 is further positioned such that the fluid emerging from it is injected into the milling drum interior 15, where it is mixed together with the milled portions of the ground material 19 and the aggregate 20. The processed milled material produced from ground material, aggregate and added fluid may, for example, remain in the milling bed.

In the area of the fluid delivery line 13, a valve device 22 is arranged between the fluid delivery pump 14 and the fluid outlet device 11. Said valve device is adjustable between a blocking position, in which it blocks a fluid-conducting connection to the fluid outlet device 11, and an outlet position, in which it unblocks a fluid-conducting connection to the fluid outlet device 11. The valve device 22 may thus comprise one or more shut-off valves or other shut-off devices. It is also possible that the fluid outlet device 11, in particular the valve device 22, can be positioned or adjusted in various outlet positions, in particular in the range between a minimum and a maximum outlet position. The adjustment of an outlet position within this range may also be infinitely variable. The valve device 22 or the adjusting position of the valve device 22 may be controlled by the control device 8 via a suitable control line 12.

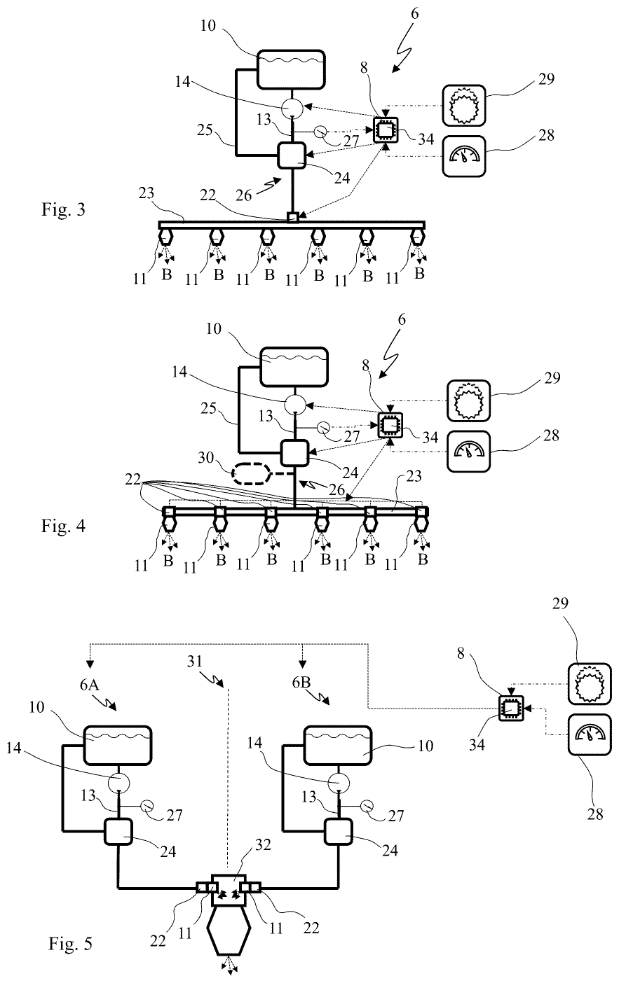

FIGS. 3 to 5 show various embodiment examples of the fluid dispensing device 6.

According to FIG. 3, a fluid-conducting fluid delivery line 13 may be present from the fluid source 10 to the fluid outlet device 11, which in the present case is a plurality of spray nozzles arranged on a spray bar 23. A fluid feed pump 14 is arranged in the fluid delivery line 13, which delivers fluid from the fluid source 10 towards the fluid outlet device 11. The fluid source 10 may be a fluid tank carried along on the ground milling machine 1 or a connection point of the ground milling machine 1 for connecting it to a fluid supply vehicle, for example a water truck.

In the present embodiment example according to FIG. 3, the valve device 22 is arranged centrally upstream of the inlet of the fluid into the spray bar 23. If the one valve device 22 is in its blocking position, fluid does not reach any of the individual spray nozzles of the fluid outlet device 11. If, on the other hand, the valve device 22 is moved to its outlet position, all spray nozzles of the fluid outlet device 11 are centrally supplied with fluid, i.e., fluid emerges from all individual outlets of the fluid outlet device 11 in fluid outlet direction B. The area of the fluid delivery line 13 in the fluid delivery direction between the fluid delivery pump 14 and the fluid outlet device 11, in particular at least the valve device 22, is also referred to as the delivery area 26. In this area of the fluid delivery line 13, there is an overpressure relative to the outside environment due to the pumping action of the fluid delivery device 14 when it is in delivery mode, preferably even when the valve device 22 is in the outlet position.

The embodiment example further comprises, by way of example only, an optional pressure limiting device 24 in the fluid delivery line 13 downstream of the fluid delivery pump 14 and upstream of the valve device 22. This pressure limiting device 24 is also optional in the other embodiments. The pressure limiting device 24 is arranged in the delivery area 26 of the fluid delivery line 13, specifically between the fluid delivery pump 14 and the fluid outlet device 11. Furthermore, a bypass line 25 is provided, which connects the pressure limiting device 25 to the fluid source 10, in particular, for example, a fluid tank carried along by the ground milling machine 1. The pressure limiting device 24 is configured such that, if a pressure threshold is exceeded in the delivery area or, in particular, in the area between the fluid delivery pump 14 and the pressure limiting device 25, it discharges fluid into the bypass line 25, so that, in the present embodiment example, the fluid is returned to the fluid source 10. The pressure limiting device 24 may therefore be, for example, a pressure limiting valve controlled in particular by the control device 8.

Furthermore, a fluid pressure sensor 27 may be arranged in the delivery area 26, in particular in the area of the fluid delivery line 13 between the fluid delivery pump 14 and the pressure limiting device 24, which determines the current fluid pressure within this area of the fluid delivery line 13 and transmits it to the control device 8 via a suitable signal transmission line.

Furthermore, a traveling operation sensor 28 and/or a milling depth sensor 29 may be provided. With the aid of the traveling operation sensor 28, it is possible to determine whether or not the ground milling machine 1 is currently in traveling operation. For example, it may be determined whether a travel command has been entered via an operating device, such as a travel lever, and/or whether one or more of the travel units 2 are moving and/or whether the ground milling machine 1 is moving relative to the outside environment. The milling depth sensor 29 is configured to determine and/or monitor the milling depth FT and may, for example, have one or more distance sensors, in particular contactless sensors, which measure the distance of a reference structure of the ground milling machine, the distance of which to the ground depends on the current milling depth, and/or one or more displacement sensing devices, for example for actuators for changing the lifting position of the milling device relative to the ground substrate and/or relative to a reference structure of the ground milling machine.

The sensors 27, 28 and/or 29 may be in signal transmission connection with the control device 8, as shown by the dashed arrows in FIG. 3. With the aid of the sensors or the operating parameters of the ground milling machine 1 determined by the sensors, the control device 8 can determine whether the ground milling machine 1 is in standstill operation during milling operation of the milling drum, i.e., is not currently moving over the underlying ground in a working or forward direction A, as is the case, for example, when the milling drum is lowered from a transport position located above the ground surface into a milling position engaging the underlying ground at the milling depth FT, or is in working operation, in which the milling drum is moved through the underlying ground at the milling depth FT in the forward or working direction.

The control device 8 may in turn control the operation of the fluid delivery pump 14, in particular with regard to a deactivated state and a delivery operation per se and/or, depending on the embodiment, with regard to a displacement volume, a speed or the like. The control device 8 may further be configured such that, if present, it controls the pressure limiting device 24, for example with regard to activation/deactivation of a discharge of fluid via the bypass line 25 and/or with regard to a pressure threshold or a pressure threshold value above which a discharge via the bypass line 25 takes place. Finally, the control device 8 may be configured such that it controls the position or the operating state of the valve device 22 between the blocking position and the outlet position.

The control specifications provided by the control device 8 may vary, in particular depending on the current milling depth FT. The control device 8 may therefore have a computing unit 34 comprising a computer program with a suitable control algorithm, a characteristic map or the like, configured to determine current control specifications.

The embodiment example according to FIG. 4 differs from the embodiment example described for FIG. 3 on the one hand essentially in that here each individual spray nozzle of the spray bar is associated with an individual valve device 22. Accordingly, individual outlet openings or spray nozzles of the fluid outlet device 11 can be individually blocked and/or opened.

On the other hand, a fluid pressure accumulator 30 may be provided, which is connected to the delivery area 26 of the fluid dispensing device 6, specifically, for example, in the area of the fluid delivery line 13 between the fluid delivery pump 14 and the fluid outlet device 11. In particular, the fluid pressure accumulator 30 is a pressure accumulator that can be charged with fluid under pressure. The fluid pressure accumulator 30 thus provides a fluid reservoir on the pressure side downstream of the fluid delivery pump 14 within the fluid delivery line 13, which can be filled with fluid against a charging pressure of the fluid pressure accumulator 30 when an internal pressure rises, for example also controlled by a suitable valve device above a pressure threshold. If the fluid outlet device 11, in particular the valve device 22, is moved from the blocking position to the outlet position, the fluid pressure accumulator 30 also discharges.

Based on the embodiment examples of FIGS. 3 and 4, the embodiment example according to FIG. 5 shows an example of the structure of a fluid dispensing device configured as a foamed bitumen system 31. This device essentially comprises two individual fluid dispensing devices 6, specifically a first fluid dispensing device 6A for water in particular and a second fluid dispensing device 6B for bitumen. With regard to possible configurations of these fluid dispensing devices 6A and 6B, reference is made to the preceding discussion. In this case, however, the fluids emerging from the respective fluid dispensing devices 6A and 6B, usually water and bitumen, are first brought into contact with each other in a mixing chamber 32 and the foamed bitumen produced in this process is then discharged via, for example, a foamed bitumen nozzle 33, in particular into the milling drum box interior 15. The valve devices 22 are located at the inlet to this mixing chamber 32.

Both of the fluid dispensing devices 6A and 6B can be controlled together by the control device 8.

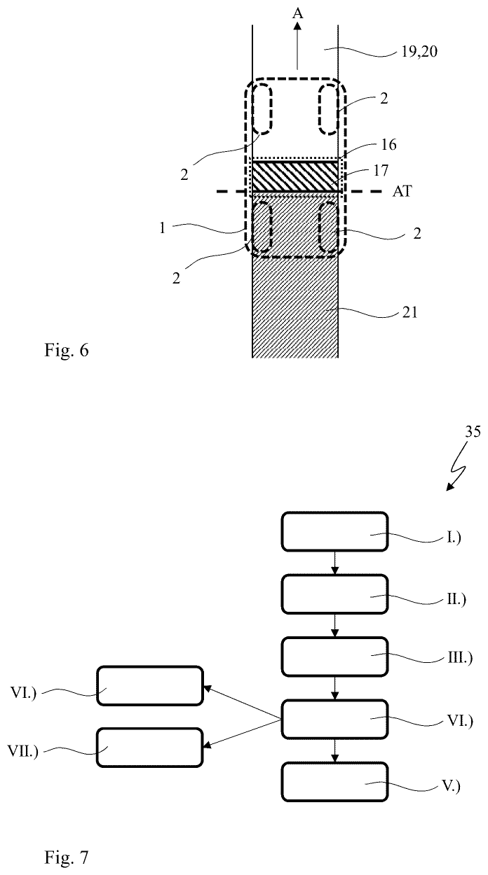

FIG. 6 illustrates a typical operating situation of a ground milling machine 1, in particular during stabilization and/or recycling work, in a top view. The ground to be worked is often processed in several strip-like sections, which may also be connected to each other at their ends, as shown in FIG. 6. In this respect, there is an initial contact point AT at which an already processed ground area (area 26 in FIG. 6) adjoins an as yet unprocessed area (area 19,20 in FIG. 6). The aim is to achieve a comparable result in particular for the area of this initial contact point in terms of moisture content and mixing of the ground material relative to area 21 and/or the ground processing area adjacent to the initial contact point AT in working direction A. Usually, the ground milling machine 1 is first maneuvered to the initial contact point with the milling drum in the transport position. With the ground milling machine 1 at a standstill, milling operation of the milling drum is then started, i.e., it is first set in rotation about its rotation R and then lowered from the transport position to its milling position at a milling depth FT. The ground milling machine 1 is at this point still at a standstill or in standstill operation. Once the milling drum 17 has reached the milling depth FT, the ground milling machine 1 is accelerated from standstill in the direction of its working direction A and thus switches from standstill operation to working operation.

In order to now ensure that sufficient fluid is also available immediately at the start of working operation, i.e., when the ground milling machine 1 switches from standstill operation to working operation and starts to move in working direction A with the milling drum milling, according to the invention, the delivery area 26 or at least the area of the fluid delivery line 13 between the fluid delivery pump 14 and the valve device 22 is hydraulically preloaded, as will be described in more detail below.

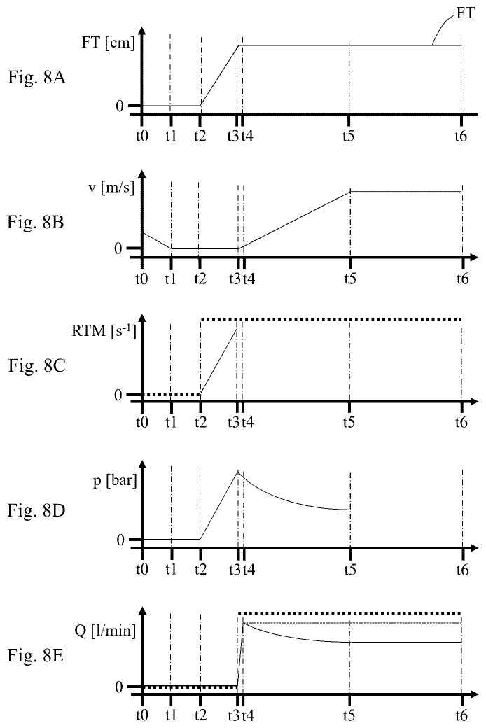

In this regard, FIG. 7 illustrates a flow chart of a method 35 for controlling the operation of a fluid dispensing device 6 of a ground milling machine 1, in particular thus of a ground milling machine 1 as described by way of example in the preceding figures. FIGS. 8A to 8E illustrate, schematically and partially exaggerated, changes to various control specifications and/or operating parameters, as they may occur when carrying out the method shown in FIG. 7. FIG. 8A illustrates a curve of the milling depth, FIG. 8B a curve of the actual travel speed of the ground milling machine, FIG. 8C the speed of the fluid delivery pump 14, FIG. 8D the internal pressure within the fluid delivery line 13 in the area downstream of the fluid delivery pump 14 and upstream of the valve device 22, and FIG. 8E the volume flow of fluid through the fluid outlet device 11. Furthermore, times t0 to t6 are indicated in the individual graphs.

In a first step, the method comprises positioning I. the milling drum situated in the transport position at an initial contact point. In the graphs according to 8A to 8E, this relates to the period t0 to t1. The ground milling machine maneuvers according to FIG. 8B and stops at time t1 in its position at the initial contact point AT. The fluid delivery pump 14 is deactivated, so that the internal pressure according to FIG. 8D is zero compared to the outside environment and no fluid exits the fluid outlet device 11 (FIG. 8E).

Step II. now comprises activating milling operation. The milling drum is thus accelerated about its rotation axis R until it has reached its set speed at time t2. The other parameters do not change between t1 and t2. In particular, the milling drum is still in the transport position. The ground milling machine 1 itself is in standstill operation.

At time t2, the lowering III.) of the milling drum from the transport position to the milling position starts, until a defined milling depth FT is reached at time t3. This means that the milling drum is lowered to the milling depth FT and engages the ground. The ground milling machine is still in standstill operation.

However, according to FIG. 8C, the fluid delivery pump 14 already starts its delivery operation at time t2, i.e., is activated according to step IV.), as illustrated by the change in the dashed line in FIG. 8C. This can generally take place at any time between t0 and t3. As a result, the pressure (FIG. 8D) within the fluid delivery line 13 or in the delivery area 26 between the fluid delivery pump and the valve device 22, which is still in the blocking position, increases. In this phase, the fluid dispensing device 6 is thus preloaded, as no fluid is yet dispensed via the fluid outlet device 11 (FIG. 8E). The speed and/or the internal pressure up to which the fluid delivery pump preloads may be specified manually, varied depending on the current milling depth or fixed by the control unit 8.

Finally, at time t3, the ground milling machine 1 starts traveling operation in the working or forward direction A (FIG. 8B) and thus changes from standstill operation to working operation during milling operation. With the start of working operation, step V.) of switching the valve device 22 from the blocking position to the release position is performed depending on the start of traveling operation of the ground milling machine, and thus fluid is dispensed via the fluid outlet device. If the valve device 22 is moved from the blocking position to the outlet position (dashed line in FIG. 8E), the full volume flow of fluid emerging from the fluid outlet device is available practically instantaneously from t3 to t4 due to the existing preload.

In the period t4 to t5, the overall system now approaches an essentially constant state with regard to the operating parameters shown, which begins at t5 and is maintained until t6 in this example (i.e., the end of a milling track, for example).

Overall, it is shown that due to the early start phase of the delivery operation of the fluid delivery pump with the valve device 22 closed, the desired volume flow from the fluid outlet device 11 is available very quickly at the beginning of working operation.

The excess volume flow between t4 and t5 compared to the constant volume flow between t5 and t6 can still be increased quantitatively, for example by using a fluid pressure accumulator.

If a pressure limiting device is provided, it may discharge fluid from the delivery area in a step VI.) if a pressure threshold value is exceeded within the delivery area.

If a fluid pressure accumulator 30 is provided, it may be filled with fluid in step VII.), in particular when the fluid delivery pump 14 is activated in step IV).

The explained embodiment example of the method 35 may also be used to produce foamed bitumen, in which case the first fluid dispensing device 6A and the second fluid dispensing device 6B may both be controlled in a method corresponding to FIG. 7, in particular with the curves illustrated in FIGS. 8A to 8E.

### LIST OF REFERENCE NUMERALS

1 ground milling machine
2 travel units
3 machine frame
4 travel drive device
5 ground milling device
6 fluid dispensing device
6A first fluid dispensing device
6B second fluid dispensing device
7 primary drive unit
8 control device
9 operator platform
10 fluid source
11 fluid outlet device
12 control line
13 fluid delivery line
14 fluid delivery pump
15 milling drum box interior
16 milling drum box
17 milling drum
18 underlying ground
19 ground material
20 aggregate
21 processed ground material
22 valve device
23 spray bar
24 pressure limiting device
25 bypass line
26 delivery area
27 fluid pressure sensor
28 traveling operation sensor
29 milling depth sensor
30 fluid pressure accumulator
31 foamed bitumen system
32 mixing chamber
33 foamed bitumen nozzle
34 computing unit
35 method
I. positioning
II. activating milling operation
III. lowering
IV. activating delivery operation
V. switching
VI. discharging
VII. filling
A working/forward direction
B fluid outlet direction
R rotation axis
FT milling depth
AT initial contact point

What is claimed is:

1. A method for controlling the operation of a fluid dispensing device of a ground milling machine,
a. the ground milling machine comprising:
a machine frame supported by travel units;
a travel drive device at least partially driving the travel units;
a ground milling device with a milling drum arranged inside a milling drum box interior and rotatable about a rotation axis in a milling operation for milling and/or mixing the underlying ground, the milling drum being adjustable between a transport position lifted out of the underlying ground and a milling position engaging the underlying ground; and
the fluid dispensing device;
b. the fluid dispensing device comprising:
a fluid source;
a fluid outlet device;
a fluid delivery pump which in delivery operation delivers fluid from the fluid source towards the fluid outlet device via a fluid delivery line;
a valve device in a delivery area of the fluid delivery line between the fluid delivery pump and the fluid outlet device, the valve device being adjustable between a blocking position and an outlet position;
c. the method comprising the steps of:
I. positioning the milling drum situated in the transport position at an initial contact point;
II. activating milling operation;
III. lowering the milling drum from the transport position to the milling position at a defined milling depth;
IV. in the course of steps I.) to III.) or upon reaching the defined and/or specified milling depth, activating delivery operation of the fluid delivery pump with the valve device in the blocking position;
V. switching the valve device from the blocking position to the release position depending on a start of traveling operation of the ground milling machine, and discharging fluid via the fluid outlet device.

2. The method according to claim 1, wherein:
it comprises manually specifying or determining a normal dosage specification, in particular a normal fluid flow;
it comprises determining a starting dosage specification, in particular a starting fluid flow, depending on the defined and/or specified milling depth and/or the normal dosage specification, the starting dosage specification deviating from the normal dosage specification, and wherein a step VI. comprises switching from an operation of the fluid dispensing device with a fluid output according to the starting dosage specification to an operation of the fluid dispensing device with a fluid output according to the normal dosage specification.

3. The method according to claim 1, wherein:
a pressure limiting device is provided in the delivery area of the fluid delivery line between the fluid delivery pump and the fluid outlet device, in particular the valve device, and in that, when a pressure threshold value specified by the pressure limiting device is exceeded;
delivery operation of the fluid delivery pump is reduced or stopped; and/or
fluid delivered by the fluid delivery pump is discharged from the fluid delivery line via a bypass line.

4. The method according to claim 3, wherein it comprises changing the pressure threshold value depending on the defined and/or specified milling depth.

5. The method according to claim 1, wherein the start of traveling operation is detected depending on:
a travel control command, in particular a travel lever deflection;
a travel unit movement;
a movement of the ground milling machine relative to the underlying ground.

6. The method according to claim 1, wherein step IV. comprises filling a fluid pressure accumulator in the delivery area of the fluid delivery line between the fluid delivery pump and the fluid outlet device, in particular the valve device, and in that step V. comprises emptying the fluid pressure accumulator in addition to the delivering of fluid performed by the fluid delivery pump.

7. The method according to claim 1, wherein the ground milling machine is configured to produce foamed bitumen and comprises two fluid dispensing devices which open with their fluid outlet devices into a mixing chamber.

8. A ground milling machine comprising:
a machine frame supported by travel units;
a travel drive device at least partially driving the travel units;
a ground milling device with a milling drum arranged inside a milling drum box interior and rotatable about a rotation axis in a milling operation for milling and/or mixing the underlying ground, the milling drum being adjustable between a transport position lifted out of the underlying ground and a milling position engaging the underlying ground; and
a fluid dispensing device;
the fluid dispensing device comprising:
a fluid source;
a fluid outlet device;
a fluid delivery pump which in delivery operation delivers fluid from the fluid source towards the fluid outlet device via a fluid delivery line;
a valve device in a delivery area of the fluid delivery line between the fluid delivery pump and the fluid outlet device, the valve device being adjustable between a blocking position and an outlet position, wherein a control device is configured to control operation of the fluid dispensing device in accordance with a method comprising the steps of:
I. positioning the milling drum situated in the transport position at an initial contact point;
II. activating milling operation;
III. lowering the milling drum from the transport position to the milling position at a defined milling depth;
IV. in the course of steps I.) to III.) or upon reaching the defined and/or specified milling depth, activating delivery operation of the fluid delivery pump with the valve device in the blocking position;
V. switching the valve device from the blocking position to the release position depending on a start of traveling operation of the ground milling machine, and discharging fluid via the fluid outlet device.

9. The ground milling machine according to claim 8, wherein it has a traveling operation sensor, in particular a travel lever position sensor and/or a travel unit movement sensor, configured to determine the presence of a traveling operation.

10. The ground milling machine according to claim 8, wherein it has a milling depth sensor configured to determine a defined and/or present milling depth.

11. The ground milling machine according to claim 8, wherein it comprises a fluid pressure sensor configured such that it can be used to detect a fluid pressure existing in an area of the fluid delivery line between the fluid delivery pump and the fluid outlet device, in particular the valve device.

12. The ground milling machine according to claim 8, wherein a pressure limiting device, in particular controlled by the control device, is provided in an area of the fluid delivery line between the fluid delivery pump and the fluid outlet device, in particular the valve device.

13. The ground milling machine according to claim 12, wherein a bypass line is provided, via which fluid can be discharged from an area of the fluid delivery line between the fluid delivery pump and the fluid outlet device, in particular with recirculation to the fluid source.

14. The ground milling machine according to claim 8, wherein the control device has a computing unit configured to calculate:
a normal dosage specification and/or a starting dosage specification; and/or
a pressure threshold value;
depending on a defined and/or specified milling depth.
